(19) United States
(12) Patent Application Publication
(10) Pub. No.: US 2003/0231414 A1
(43) Pub. Date: Dec. 18, 2003

(54) Wing mirror for vehicles

(76) Inventor: Bau-Lin Chen, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/187,356

(22) Filed: Jul. 2, 2002

(30) Foreign Application Priority Data
Jun. 14, 2002 (TW) 091208925

(51) Int. Cl. G02B 5/08

(52) U.S. Cl. 359/850; 359/864

(57) ABSTRACT

A wing mirror for vehicles includes a reflector having a flat region to serve as a planar mirror, and two curved regions integrally formed on outer and bottom sides of the flat region to serve as convex mirrors so as to give a view of a wide angle to the driver and avoid blind side. Furthermore, the integral formation of the curved regions with the flat region allows an existing wing mirror to be changed from a conventional type into the inventive type simply by replacing with the inventive reflector.

### BACKGROUND OF THE INVENTION

1. Field of the Invention

The present invention relates to a wing mirror for vehicles and, more particularly, to a wing mirror which is used for vehicles to provide the driver with an improved visual angle.

2. Description of Prior Art

Wing mirrors are widely used in vehicles and are made in various forms in considerations to the visual angle these mirrors may provide.

Most of such mirror, as shown in FIG. 1, generally includes a holder 1 that holds a planar mirror 2. Although the planar mirror 2 gives a clear view of conditions behind the related vehicle, there are still bind sides at which the driver can not look.

A wing mirrors is also known in which a small convex mirror 3 is formed in a planar mirror 2 to give a view of an improved angle to the driver. However, the improvement in the visual angle is limited and the convex mirror 3 directly in the flat mirror 2 has a obviously negative influence upon the vision of the driver as he/she takes a glance at the view given by the planar mirror 2.

### SUMMARY OF THE INVENTION

The object of the present invention is to provide a wing mirror in which a reflector has a flat region to serve as a planar mirror and curved regions formed on the outer and bottom sides of the flat region to serve as convex mirrors for giving a view of a wide angle and avoiding blind side.

Another object of the present invention is to provide a wing mirror in which the curved regions cover only a fraction of total area of the reflector and so have no sufficiently negative influence upon the vision of the driver as he/she takes a glance at the view given by the flat region.

Still another object of the present invention is to provide a wing mirror in which the curved regions are formed integrally with the flat region, thereby allowing a wing mirror to be changed from a conventional type into the inventive type simply by replacing with the reflector but not its holder.

These objects can be accomplished by an improved wing mirror constructed in accordance with the present invention. The inventive wing mirror includes a reflector having a flat region to serve as a planar mirror and curved regions formed on outer and bottom sides of the flat region to serve as a convex mirror, so as to give a view of a wide angle to the driver and avoid blind side.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a conventional wing mirror;

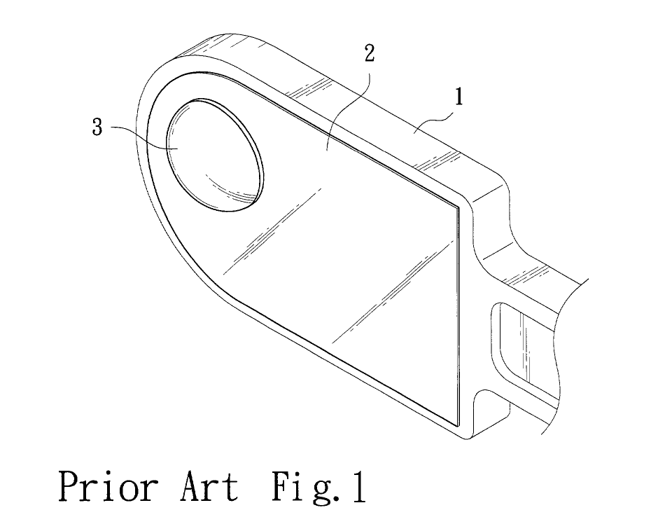

FIG. 2 is a perspective view of a reflector involved in a wing mirror constructed in accordance with the present invention;

FIG. 3 is a perspective view of the wing mirror constructed in accordance with the present invention; and

FIG. 4 is a perspective view showing a vehicle provided with the wing mirror of FIG. 3.

### DETAILED DESCRIPTION OF THE PREFERRED EMBODIMENT

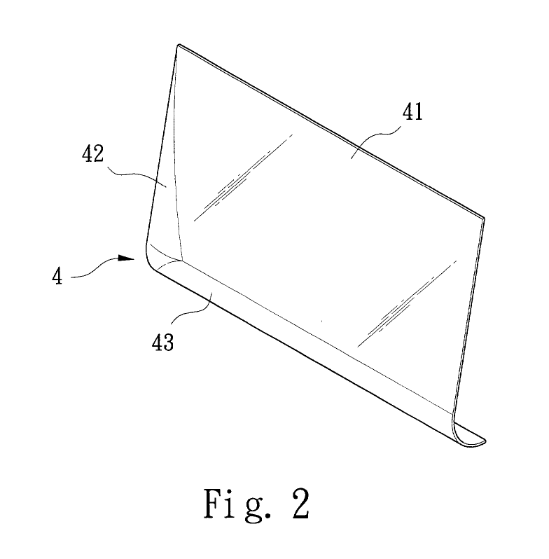

Referring to FIG. 2, an inventive wing mirror for a vehicle includes a reflector 4 having a flat region 41 shaped into a planar mirror, with a first curved region 42 formed on an outer side and a second curved region 43 formed on a bottom side of the flat region 41.

The two curved regions 42, 43 are shaped into convex mirrors and are formed integrally with the flat region 41. These curved regions 42, 43 can provide the driver with an improved visual angle and avoid blind side, thereby ensuring the safety of the vehicle during its driving and parking.

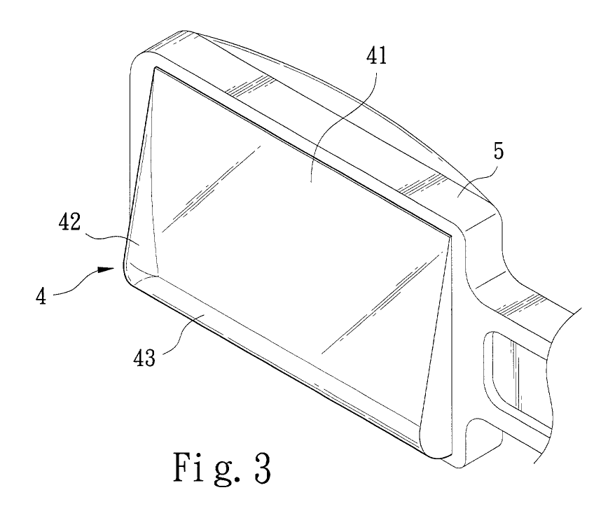

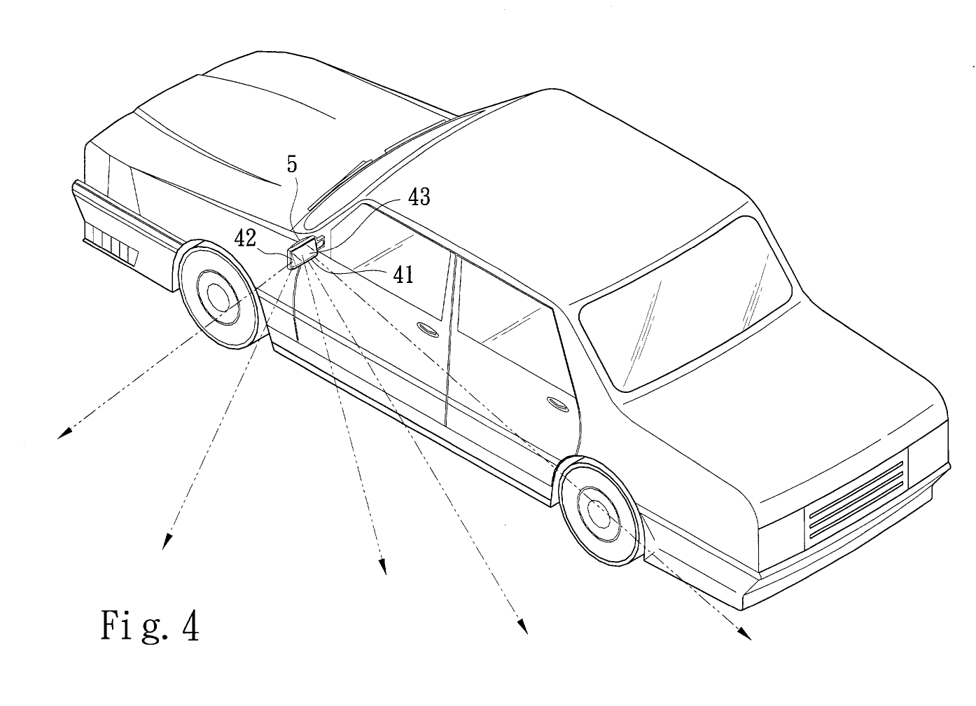

Referring to FIGS. 2 to 4, the complete wing mirror can be obtained by mounting the reflector 4 onto a holder 5. Now the flat region 41 in the reflector 4 serves as a planar mirror at which the driver may take a glance and estimate the distance from any other vehicle behind his/her own one. The first curved region 42, preferably shaped into a conical configuration, serves as a convex mirror which may give a view of a wide angle at either roadway nearby the vehicle, while the second curved region 43 serves as an additional convex mirror which gives a clear view of the ground and the rear wheel(s), a clear view sufficient to avoid collision while the vehicle goes astern or is slowed down to be parked, such as alongside the pavement.

The curved regions 42, 43 cover an area only about 5 percent to about 25 percent of total area of the reflector 4, and hence have no sufficiently negative influence upon the estimation of the driver as he/she takes a glance at the view given by the flat region 41.

In addition, the integral formation of the curved regions 42, 43 with the flat one 41 facilitates the change of a wing mirror from a conventional type into the inventive type. It is only necessary to replace with the new reflector 4 but not the holder 5.

With the curved regions 42, 43 formed on the sides of the flat one 41, the driver is given a view of a wide angle which avoids any blind side. So it become much safer and easier for the driver to drive his/her vehicle or to park it.

Although the curved regions 42, 43 has been illustrated to be formed on the outer and bottom sides of the flat region 41 for providing the driver with an improved visual angle, they may actually be formed in anywhere on the periphery of the flat one 41 for the same purpose.

From the foregoing, it is apparent that this invention has the advantages as follow:

1. The first curved region formed on the outer side of the flat region may serve as a convex mirror to give a view of a wide angle and avoid blind side upon either roadway nearby the vehicle;

2. The second curved region formed on the outer side of the flat region may serves as an additional convex mirror to give a clear view of the ground and the rear wheel(s), so as to avoid collision when the vehicle goes astern or is slowed down to be parked.

3. The curved regions cover only a fraction of the total area of the reflector and have no sufficiently negative influence upon the estimation of the driver as he/she takes a glance at the flat region.

4. The integral formation of the curved regions with the flat region allows a wing mirror to be changed from a conventional type into the inventive type simply by replacing with the inventive reflector but not the holder.

While the principles of this invention have been disclosed in connection with specific embodiment, it should be understood by those skilled in the art that these descriptions are not intended to limit the scope of the invention, and that any modification and variation without departing the spirit of the invention is intended to be covered by the scope of this invention defined only by the appended claimed.

What is claimed is:

1. A wing mirror for vehicles comprising a reflector having a flat region to serve as a planar mirror and at least one curved region formed on a periphery of said flat region to serve as a convex mirror.

2. The wing mirror as claimed in claim 1, wherein said reflector has a curved region formed on a bottom side of said flat region.

3. The wing mirror as claimed in claim 1, wherein said reflector has a curved region formed on an outer side of said flat region.

4. The wing mirror as claimed in claim 3, wherein said curved region formed on said outer side of said flat region is shaped into a conical configuration.

5. The wing mirror as claimed in claim 1, wherein said at least one curved region covers an area about 5 percent to about 25 percent of total area of said reflector.

6. The wing mirror as claimed in claim 1, wherein said at least one curved region is formed integrally with said flat region.
